(19) United States
(12) Patent Application Publication
(10) Pub. No.: US 2022/0178342 A1
(43) Pub. Date: Jun. 9, 2022

(54) WAVE ENERGY CONVERTER CELL

(71) Applicant: BOMBORA WAVE POWER EUROPE LTD, Pembroke Dock, Pembrokeshire (GB)

(72) Inventors: Campbell Robert ALGIE, Narberth (GB); Carl Bernard VANCE, Tenby (GB); Paul VIGARS, Frampton Cotterell (GB); Dylan HEATH, Kununurra (AU)

(73) Assignee: BOMBORA WAVE POWER EUROPE LTD, Pembroke Dock, Pembrokeshire (GB)

(21) Appl. No.: 17/437,330

(22) PCT Filed: Mar. 11, 2020
(86) PCT No.: PCT/EP2020/056561

§ 371 Date: Sep. 8, 2021

(30) Foreign Application Priority Data
Mar. 11, 2019 (GB) 1903230.9

(51) Int. Cl. F03B 13/18; F03B 13/24

(52) U.S. Cl. CPC F03B 13/18; F03B 13/24

(57) ABSTRACT

A wave energy converter cell for a pressure differential converter system includes a turbine. The cell includes a cell body defining an aperture and a membrane sealing the aperture wherein the membrane has a distensible working surface extending across the aperture. The membrane may be planar and may be pre-strained over the aperture.

### FIELD OF THE INVENTION

The present disclosure relates to a wave energy converter (WEC) cell and to methods of wave energy conversion utilising an energy transfer fluid such as air. In particular, the disclosure relates to a WEC cell and energy conversion methods for a pressure differential wave energy converter system comprising a turbine.

### BACKGROUND

Wave energy conversion systems for generating electrical energy from wave energy are well known. A number of different systems have been proposed including oscillating water column devices and pressure differential converters.

Oscillating water column (OWC) devices harness energy from the vertical oscillation of seawater inside an open-ended, typically cylindrical chamber. The chamber is semi-submerged with the lower end of the chamber being open to the water with a trapped air pocket at the upper end. Waves force the column of water within the chamber to act like a piston which, in traditional OWCs, moves to force air in and out of the chamber. This results in a flow of air which is either channeled though a bidirectional turbine in a power take-off system or through a valve system through a unidirectional turbine.

These OWC devices often require water to change direction and flow around non-streamlined edges. This increases friction and energy losses within the system and can introduce lag which can prevent good coupling with the wave motion. OWC devices also typically require a considerable amount of material in their construction, installation and anchoring relative to the power output of the systems. The bidirectional turbine is exposed to salt-laden air which can increase the costs for corrosion resistance and maintenance costs of the turbine.

Submerged pressure differential converters (some of which are also known as membrane power conversion devices/converters or membrane-pneumatic power conversion devices/converters) use the difference in hydrostatic pressure at different locations below a wave (depending on the vertical height of water above the converter) to produce a pressure difference within cells connected to a closed power take-off system. The pressure difference results in flow of a low inertia, low friction energy transfer fluid (e.g. air) within the closed power take-off system which transmits energy to a turbine and electrical generator (which are not exposed to any salt-laden air).

The cells are each typically provided with a flexible (usually fibre-reinforced industrial rubber) membrane as the working surface between the seawater and the closed power take-off system, the flexible membrane allowing for a large change in the geometry of the working surface which can be used to provide a large swept cell volume. The fibrous reinforcement of the membrane protects it from excessive loads in extreme conditions.

Bombora's mWave™ system is an example of a submerged pressure differential converter and features a series of air-filled cells mounted on the sea bed. Each cell is defined by a cell body having a concave cell wall and an inflated, dome-shaped flexible rubber membrane working surface which is angled to the direction of the incoming waves. As a wave passes over the cells, the flexible membrane geometry responds to the hydrodynamic pressure of the wave and air inside the cells is squeezed into a duct (through a one-way check valve provided in the cell wall) and through a turbine. A generator uses the rotation of the turbine to produce electricity. The air is recycled to re-inflate the membrane ready for the next wave.

WO2014/026219 owned by Bombora describes the flexible membrane having a cross-sectional length which substantially matches the cross-sectional length of the cell wall (e.g. concave cell wall) so that when fully-deflated (when there is the maximum hydrostatic pressure (i.e. a wave peak) above the cell), the flexible membrane can conform to the cell wall without any significant induced stresses in the membrane.

However, one problem that occurs when the membrane conforms to the cell wall in its completely deflated state, is that stiction occurs during re-inflation.

The membrane described in WO′219 may have a beaded or splined perimeter which is then clamped into a channel or groove on the cell body. Alternatively a clamp ring is provided to clamp the perimeter of the membrane to the cell body. These fixing arrangements can be problematic as debris and biofouling (e.g. barnacles) can collect on the outer surface of the membrane in the vicinity of the clamp. The repetitive movement of the membrane between its inflated and deflated states can result in damage to the membrane as it rubs against the debris/barnacles in the vicinity of the clamp.

WO2017/143399 also owned by Bombora describes the flexible membrane having a greater membrane length than a straight-line distance between two points on the membrane.

The aim of WO'399 is to obtain a low (preferably zero) membrane pressure-volume (PV) stiffness during inflation/deflation of the membrane in order to increase wave energy capture efficiency. The PV stiffness is defined as the rate of change in the membrane pressure differential (i.e. the difference at a defined reference point between the external and internal pressure across the membrane) with respect to cell volume. Where a flexible, deflectable membrane is used, the PV stiffness is dependent only on hydrostatic stiffness of the changing cell volume which can be adjusted by adjusting the chord length and chord angle of the membrane.

One problem with the known membranes that have a membrane length greater than the chord length and which adjust the volume of the cell through a change in the 3D geometry of the flexible membrane is that buckling/creasing can occur during deflection between the inflated and deflated configurations thus inducing high bending stresses in parts of the membrane during the inflation/deflation strokes. In addition, these 3D pre-shaped membranes have to be manufactured in multiple sections that are subsequently joined or manufactured in a single section with expensive, customised tooling. The joints present weakness in the membrane that may be prone to failure particularly when the membrane is subjected to high dynamic loads under extreme wave conditions.

To strengthen the known membranes (i.e. to increase the tensile stiffness), reinforcing fibres and/or meshes are incorporated into the rubber. Fretting of the rubber by the fibres/mesh is a known failure mode for such reinforced rubber. Furthermore, the substantially continuous and repetitive movement of the membranes between the inflated and deflated configurations can result in delamination of the membrane.

There is a desire to provide a WEC cell that ameliorates at least some of the problems associated with the known systems.

### SUMMARY

In a first aspect, there is provided a wave energy converter cell for a pressure differential converter system comprising a turbine, the cell comprising a cell body defining an aperture and a membrane sealing said aperture wherein said membrane has a working surface covering said aperture and wherein said working surface is distensible.

As discussed above, the known cells of pressure differential converter systems having a turbine use pre-shaped, 3D domed membranes that change geometry (and thus cell volume) through flexing/deflecting (rather than distending) between inflated and deflated configurations. The fibrous/meshed reinforcements in the prior art membranes increase the tensile stiffness and prevent distension of the membranes even under the high dynamic loads which may occur under extreme conditions.

The present inventors have found that by using a membrane having a working surface that is distensible to change the cell volume during the inflation/deflation stroke, creasing and buckling in the working surface of the membrane are substantially eliminated thus substantially reducing bending stresses in the membrane.

The term “distensible” is intended to refer to a working surface that is capable of increasing its surface area by 2% or greater e.g. by 5% or greater, such as 10% or greater, for example 20% or greater, 30% or greater, 40% or greater, 50% or greater, 60% or greater or 70% or greater, e.g. up to a maximum of 100% or 150% or 200%. In preferred embodiments, the working surface of the membrane is distensible such that its surface area can increase by an amount between 20 and 80%, e.g. between 40% or 50% and 70% such as around 60%.

Furthermore, by using a distensible working surface, the PV stiffness becomes dependent not only on the hydrostatic stiffness but also on the mechanical stiffness of the membrane working surface. For a membrane having a working surface facing water on its upper side and facing an energy transfer fluid such as air on its lower side, the mechanical stiffness (which is attributable in part to the elastomeric nature of the distensible membrane) can be used to off-set the hydrostatic stiffness given that they have the opposite effect. Hydrostatic stiffness will be negative because a decrease in hydrostatic pressure (resulting in inflation of the membrane) tends to further reduce hydrostatic pressure as the inflation further reduces the height of water above the cell. In contrast, as the membrane is distended to the inflated configuration, the elastomeric properties of the membrane will resist further distension thus offsetting the decrease in hydrostatic pressure.

The working surface of the membrane will have a membrane hydrostatic stiffness which can be defined as the rate of change in total hydrostatic pressure on the working surface as a function of cell volume. This can be tailored by appropriate selection of the membrane (working surface) chord ratio/length and/or chord angle, for example.

Accordingly, in some embodiments, the membrane hydrostatic stiffness of the working surface is approximately equal and opposite to its mechanical stiffness (in terms of effect on pressure-volume stiffness). In other words, the membrane hydrostatic stiffness can configured to be substantially equal and opposite to the mechanical stiffness of the membrane, for example by selection of at least one of an appropriate chord length/ratio/inclination (for determining hydrostatic stiffness).

Given that the mechanical stiffness of the membrane can be modified e.g. through selection of the material forming the working surface of the membrane and/or adjustment of the membrane working surface thickness, there is an increased scope for tailoring the PV stiffness to optimise wave energy capture efficiency e.g. by balancing the membrane hydrostatic stiffness and mechanical stiffness.

Optional features will now be set out. These are applicable singly or in any combination with any aspect.

The cell body comprises an internal surface which, along with the distensible working surface of the membrane defines a cell volume. The cell volume is variable by distension of the working surface of the membrane away from the internal surface (in an inflation stroke) and towards the internal surface (in a deflation stroke). The distention/movement of the working surface of the membrane may be in a direction substantially perpendicular to the internal surface. An operation stroke/cycle of the membrane comprises an inflation and deflation stroke e.g. from an inflated (e.g. fully-inflated) configuration to a deflated (e.g. fully deflated) configuration. When not in the fully-deflated configuration, the cell volume will contain an energy transfer fluid such as air. In the fully-deflated configuration, the cell volume may be substantially zero i.e. the working surface of the membrane may overlie the internal surface.

The internal surface of the cell body may comprise a surface (which may comprise a concave surface) extending between opposing edges. The surface may extend from a forward edge (e.g. a lower forward edge) to a rearward (e.g. an upper rearward) edge. The perimeter/edge of the internal surface defines the aperture across which the working surface of the membrane extends. The perimeter/edge of the internal surface of the cell body may comprise a curved/rolled edge.

The perimeter/edge of the internal surface of the cell body encircling the aperture may have a race track oval shape when viewed from directly above the aperture (i.e. with linear forward and rearward edges spaced by curved transverse edges).

In some embodiments, the perimeter/edge of the internal surface of the cell body is planar i.e. the rearward, forward and transverse edges are in a single plane.

In other embodiments, at least one (e.g. both) of the transverse edges are deflected above or below the plane of the forward/rearward edges.

In yet further embodiments, the forward/rearward edges may be deflected from planar e.g. at least one (e.g. both) of the forward/rearward edges may be deflected in the same or opposite direction as the deflection of the transverse edges. For example, the forward and rearward edges may be deflected upwards from a reference plane extending across the aperture whilst the transverse edges are deflected downwards from the reference plane (thus forming a doubly curved saddle shape).

The internal surface of the cell body may comprise an outlet for flow of the energy transfer fluid to a power off-take system comprising the turbine. The outlet may comprise a one-way valve. The internal surface of the cell body may comprise an inlet for the return of air to the cell volume from the turbine. The inlet may comprise a one-way valve.

The membrane (i.e. the working surface of the membrane) is distensible from a rest configuration to an inflated (e.g. a fully inflated) configuration (i.e. it moves away from the internal surface of the cell body).

The rest configuration is the configuration of the membrane fitted to the cell when no hydrostatic pressure is applied to the cell (e.g. prior to installation i.e. prior to submerging in sea water) and with internal air pressure equal to external air pressure.

In some embodiments, the membrane (i.e. the working surface of the membrane) is distensible such that the surface area of the membrane (and the cell volume) in the inflated (e.g. fully-inflated) configuration is greater than the surface area (and the cell volume) in the rest configuration.

In some embodiments, the membrane (i.e. the working surface of the membrane) is distensible from the rest configuration to the inflated (e.g. fully-inflated) configuration such that the membrane is under strain between the rest configuration and the inflated (e.g. fully-inflated) configuration i.e. the distended membrane will be under strain as it moves away from the internal surface from the rest position to the inflated (e.g. fully-inflated) configuration. In this way, creasing/buckling of the membrane is substantially avoided.

In some embodiments, the membrane has a plurality of inflated (i.e. partly-inflated) configurations between the rest and fully-inflated configurations.

In some embodiments, the membrane (i.e. the working surface of the membrane) is distensible such that the surface area of the membrane (and cell volume) in each of the partly-inflated configurations is greater than the surface area/cell volume in the rest configuration.

In some embodiments, the membrane (i.e. the working surface of the membrane) is distensible such that the membrane is under (positive/tensile) strain in all inflated configurations i.e. the distended membrane will be under (positive/tensile) strain at all times as it moves from the rest configuration to the inflated (e.g. fully-inflated) configuration (thus avoiding creasing/buckling).

In some embodiments, the membrane (i.e. the working surface of the membrane) is distensible from the rest configuration to a deflated (e.g. a fully-deflated) configuration. The rest configuration may lie mid-way between the inflated (e.g. fully-inflated) and deflated (e.g. fully-deflated) configurations.

In some embodiments, the membrane (i.e. the working surface of the membrane) is distensible such that the surface area of the membrane (and cell volume) in the deflated (e.g. fully-deflated) configuration is greater than the surface area in the rest configuration.

In some embodiments, the membrane (i.e. the working surface of the membrane) is distensible from the rest configuration to the deflated (e.g. fully-deflated) configuration such that the membrane is under (positive/tensile) strain between the rest configuration and the deflated (e.g. fully-deflated) configuration i.e. the distended membrane will be under (positive/tensile) strain as it moves from the rest to the deflated (e.g. fully-deflated) configuration. In this way, creasing/buckling of the membrane is avoided.

In some embodiments, the membrane (i.e. the working surface of the membrane) has a plurality of deflated (i.e. partly-deflated) configurations between the rest and fully-deflated configurations.

In some embodiments, the membrane (i.e. the working surface of the membrane) is distensible such that the surface area of the membrane (and the cell volume) in each of the partly-deflated configurations is greater than the surface area in the rest configuration.

In some embodiments, the membrane (i.e. the working surface of the membrane) is distensible such that the membrane is under (positive/tensile) strain in all of the deflated configurations i.e. the distended membrane will be under (positive/tensile) strain at all times as it moves from the rest to the deflated (e.g. fully deflated) configuration (thus avoiding creasing/buckling).

The membrane (i.e. the working surface of the membrane) is movable from the inflated (e.g. fully-inflated) configuration to the deflated (e.g. fully-deflated) configuration in the deflation stroke. In some embodiments, the membrane is under (positive/tensile) strain during the entire deflation stroke. The membrane (i.e. the working surface of the membrane) is movable from the deflated (e.g. fully-deflated) configuration to the inflated (e.g. fully-inflated) configuration in the inflation stroke. In some embodiments, the membrane is under (positive/tensile) strain during the entire inflation stroke. The operation cycle/stroke of the membrane comprises the inflation and deflation strokes and in some embodiments, the membrane (i.e. the working surface of the membrane) is under (positive/tensile) strain for the entire operational cycle/stroke.

In some embodiments, the chord ratio is greater in the inflated (e.g. fully-inflated) and/or deflated (e.g. fully-deflated) configurations than in the rest configuration. The chord ratio may also be greater in the plurality of partly-inflated and/or partly deflated configurations than in the rest configuration.

The chord ratio is defined as the ratio of the length of the membrane between opposed points on the aperture (i.e. the length of the working surface) relative to a straight-line distance between the opposed points. The opposed point may be the rearward and forward edges of the perimeter of the internal surface of the cell body. This means that the length of the membrane is greater in the inflated (e.g. fully-inflated) and/or deflated (e.g. fully-deflated) configurations (and optionally in the partly-inflated/partly-deflated configurations) than in the rest configuration. In the known cells, the chord ratio is constant in all configurations of an inflation/deflation stroke as the membrane changes geometry but not length.

In some embodiments, the chord ratio equals substantially one (i.e. less than 1.01) in the rest configuration. This means that the membrane length is substantially equal to the straight line length across the aperture i.e. between the rearward and forward edges of the internal cell surface. In other words, the working surface of the membrane is substantially planar across the aperture between these edges in the rest configuration. In some embodiments, the weight of the membrane may cause it to form a slightly concave shape in the rest configuration.

Where the forward, rearward and transverse edge of the internal surface of the cell body are planar (i.e. all lie in the same plane), the membrane will be substantially planar across the entire aperture.

Having a membrane that is substantially planar across the aperture allows the manufacture of a planar membrane that has a single, unitary planar surface i.e. with no joins and without the use of customised, curved tooling. This reduces membrane manufacturing complexity and costs and also eliminates joint weakness in the membrane.

Where the forward, rearward and transverse edge of the internal surface of the cell body are not planar (i.e. at least one (e.g. both) of the rearward and/or forward edges are deflected above or below the plane of the transverse edges), the membrane will be substantially planar between the forward and rearward edges but will deflect upwards or downwards towards the transverse edges.

Accordingly, in some embodiments, the membrane has a single, unitary upper surface (facing away from the cell body) which may be planar across at least part of the aperture (between the transverse edges) e.g. across the entire aperture (where the rearward and forward edges are in the same plane as the transverse edges).

In other embodiments where both the rearward/forward edges and transverse edges are non-planar as described above, the membrane will not be planar across the aperture but, instead, will have a first curved surface extending between the forward and rearward edges and a second curved surface (intersecting the first curved surface) extending between the transverse edges.

In some embodiments, the working surface of the membrane (e.g. the planar membrane) is pre-strained across the aperture in the rest configuration i.e. a stress is applied to stretch the membrane across the aperture such that at least the working surface of the membrane is under in-plane (positive/tensile) strain in the rest configuration. The amount of pre-straining i.e. the amount of tensile stress imparted to the membrane is yet another factor that can be used to modify the mechanical stiffness of the membrane in order to offset the hydrostatic stiffness and thus tailor the PV stiffness of the cell.

In some embodiments, the working surface of the membrane is pre-strained by greater than 10% e.g. between 10 and 50% or up to 100%.

In these embodiments, where the membrane is under (positive/tensile) strain in the rest configuration, the working surface of the membrane will be under strain at all times when operating under a hydrostatic load i.e. it will be under strain at all times during the operation cycle/stroke of the membrane comprising the inflation stroke (from the deflated (e.g. fully-deflated) to the inflated (e.g. fully-inflated) configuration) and the deflation stroke (from the inflated (e.g. fully-inflated) to the deflated (e.g. fully-deflated) configuration). This ensures that membrane is never under compression and thus creasing/buckling is avoided at all times.

Furthermore, pre-straining the working surface of the membrane increases the minimum positive strain in the membrane and improves the fatigue life of the membrane by preventing undesirable cycling between positive and negative strain (i.e. between tension and compression) during an operational cycle (i.e. during the inflation and deflation strokes).

In some embodiments, the working surface of the membrane (e.g. the planar membrane) is pre-strained along a single axis across the aperture (and constrained in a perpendicular axis) in the rest configuration i.e. a tensile stress is applied along an axis to stretch the membrane across the aperture such that at least the working surface of the membrane is under in-plane (positive/tensile) strain in the rest configuration.

In some embodiments, the working surface of the membrane (e.g. the planar membrane) is pre-strained along two perpendicular axes across the aperture in the rest configuration i.e. a tensile stress is applied along two perpendicular axes to stretch the membrane across the aperture such that at least the working surface of the membrane is under in-plane (positive/tensile) strain in the rest configuration.

In some embodiments, the membrane comprises a homogenous material at least in the working surface of the membrane i.e. in the portion extending across the aperture. In other words, the membrane (e.g. the working surface of the membrane) comprises a uniform material structure and does not comprise any reinforcing fibres or mesh. This will reduce the tensile stiffness (and thus the mechanical stiffness) of the membrane.

The membrane may comprise natural rubber. It may further comprise a substantially homogenous distribution of a filler such as carbon black, at least in the working surface of the membrane i.e. in the portion of the membrane sealing the aperture.

In the absence of reinforcing fibres or mesh, it is preferable to provide some means of preventing over-inflation of the membrane which may occur under high dynamic loads in extreme wave conditions. For example, in some embodiments, the cell may further comprise a cage e.g. a domed cage, defining the inflation limit of the membrane. The cage may extend from the cell body away from the aperture. The cage may be a meshed cage.

In this way, during any excessive inflation, the membrane inflation will be limited by the inner surface (e.g. a concave inner surface) of the cage thus preventing further distension.

The thickness of the membrane may be between 20-130 mm, e.g. between 30-100 mm, such as between 40-80 mm or 40 and 70 mm, e.g. around 60 mm or 50 mm.

The membrane may have a unitary structure (i.e. it may comprise a single layer) or may have layered/laminate structure (i.e. formed of a plurality of stacked layers formed of individual thinner membranes).

The thickness of the (unitary or laminated) membrane may vary across the working surface. For example, a central portion of the working surface of the membrane (which will be aligned with the centre of the aperture) may have an increased thickness. The central portion may be subject to the greater distension and thus thickening of the central portion may help avoid over distention of the working surface.

The membrane may have a Shore A Hardness of between 30-80 e.g. between 40 and 70 such as around 60.

The membrane seals the aperture in the cell body with the working surface of the membrane extending across the aperture. The membrane further comprises a perimeter portion circumscribing the working surface.

As described above, the perimeter/edge of the internal surface of the cell body (i.e. the rearward/forward/transverse edges) defines the aperture across which a working surface of the membrane is sealed. The perimeter/edge of the internal surface of the cell body (i.e. the rearward/forward/transverse edges) may comprise a curved/rolled bearing surface.

In some embodiments, the membrane is deflected and tensioned over the curved bearing surface of the perimeter/edge of the internal surface to seal the membrane to the curved bearing surface thereby sealing the aperture. The membrane is tensioned to conform to the curved bearing surface of the internal surface. By deflecting the membrane around a curved bearing surface, the bending stress in the membrane is reduced because it is limited by the curve of the curved bearing surface.

Furthermore, by forming the seal by tensioning the membrane over a curved bearing surface to form a frictional engagement rather than clamping the membrane to or against the cell body, a “one-sided seal” is provided (i.e. the outer surface of the membrane in the region of the seal is exposed) so that problematic sealing arrangements prone to the collection of debris and biofouling (e.g. barnacles) can be eliminated. This, in turn prevents fretting of the membrane by rubbing against the debris/barnacles.

A yet further advantage of forming the seal over the aperture by deflecting and tensioning the membrane is that damage to the membrane by over inflation can be avoided by allowing venting of the energy transfer fluid through the seal (thus breaking the seal) during excessive inflation.

In some embodiments, a perimeter portion of the tensioned membrane (i.e. a portion on the opposing side of the seal to the working surface) is secured to a support structure (e.g. a skirt) such as a support structure depending/extending from the cell body e.g. depending/extending downwardly from the curved bearing surface. The frictional engagement of the membrane over the curved bearing surface of the perimeter/edge of the internal surface of the cell body also helps reduce oscillating loads on the perimeter portion of the membrane

The support structure (e.g. skirt) may at least partly circumscribe and at least partly enclose the cell body. The support structure (e.g. skirt) may be apertured/perforated to reduce the weight of the cell, provide access to the cell body and to provide securing locations.

The perimeter portion of the membrane may be connected (e.g. by circumferentially spaced membrane connectors such as eyelets provided in the perimeter portion) to a plurality of circumferentially spaced tethers/restraints e.g. ropes, cords or bungees. The support structure (e.g. skirt) may comprise a plurality of support connectors (e.g. hooks or clamps), each support connector for securing one of the plurality of tethers in order to maintain the tension within the perimeter portion of the membrane and thus the seal against the aperture. Thus the perimeter portion of the membrane is connected to the support structure at a number of discrete locations (by the connection of the tethers to the circumferentially-spaced membrane connectors (e.g. eyelets)).

The unconnected perimeter portion of the membrane (e.g. between the circumferentially-spaced membrane connectors (e.g. eyelets)) will stretch during any pre-straining of the membrane and/or during tensioning of the perimeter portion to form the seal over the aperture. It will be under strain and thus will undergo circumferential extension. This arrangement focusses the evenly distributed load on the membrane into discrete points resulting in a scalloped edge of the perimeter portion of the membrane.

The unconnected perimeter portion may alternatively be in either tension or compression, these states dependent on location. The unconnected perimeter portion may include cut-outs (e.g. between the circumferentially-spaced membrane connectors (e.g. eyelets)). For example, the unconnected perimeter portion may have a castellated/crenelated profile. These cut-outs reduce the effect on the membrane connectors of tension or compression in the perimeter portion.

The angle of the support structure/skirt and thus the exterior angle that the perimeter portion of the membrane makes with the working surface can be selected to determine the cell volume at which the seal between the membrane and aperture is broken during excessive inflation. A greater angle will provide a greater extent of distention before venting. Furthermore, a greater angle reduces the strain in the perimeter portion of the membrane as the membrane is tensioned and secured to the support structure/skirt.

In some embodiments, the perimeter portion of the membrane is thicker than the minimum thickness of the working surface and may be thicker than the maximum thickness of the working surface. Where the working surface has variations in thickness (e.g. a thicker central portion as described above), the perimeter portion of the membrane may be thicker than the portion of the membrane proximal the seal (i.e. distal the central portion). The thicker perimeter portion of the membrane may be provided to strengthen the membrane in the vicinity of the connection to the tethers.

In other embodiments, the perimeter of the membrane may be thinner than the maximum thickness of the working surface and may be thinner than the minimum thickness of the working surface. Where the working surface has variations in thickness (e.g. a thicker central portion as described above), the perimeter portion of the membrane may be thinner than the portion of the membrane proximal the seal (i.e. distal the central portion). The thinner perimeter portion of the membrane may be provided to facilitate connection of a thicker membrane to the tethers.

The perimeter portion of the membrane may additionally or alternatively be strengthened by reinforcing elements. The reinforcing elements may comprise a woven material. The woven material may comprise a polymeric material such as a polyamine (e.g. Kevlar™) or polyethylene (e.g. high molecular weight polyethylene such as Dyneema®). The reinforcing elements may be darted to provide a gradual increase in stiffness towards the extremity of the perimeter of the membrane.

The perimeter portion of the membrane may comprise a reinforced perimeter edge e.g. reinforced by a rope/cable/wire which may encircle the circumferentially-spaced membrane connectors (e.g. eyelets).

In other embodiments, a reinforced perimeter edge of the membrane (e.g. reinforced with a bolt-rope or similar, may be clamped onto or into the support structure/skirt. Although the clamping arrangement may be prone to debris capture/biofouling in these embodiments, given that only the working surface (and not the perimeter of the membrane) is subject to repetitive inflation/deflation, fretting/rubbing damage to the membrane should still be avoided.

In a second aspect, there is provided a pressure differential wave energy converter system comprising at least one cell according to the first aspect and a closed power take-off system comprising a turbine.

The turbine may be a unidirectional or a bidirectional turbine.

The system may comprise a plurality of cells according to the first aspect.

The cell(s) i.e. the membrane(s) of the cell(s) may be fully submerged within seawater during normal use.

The cell, or at least one of the cells, may be arranged such that their respective membranes are angled with respect to an incoming wave direction i.e. the chord angle of the working surface of the membrane may be inclined with respect to an incoming wave direction. The membrane(s) may be angled/inclined with respect to a horizontal plane (e.g. generally parallel to the seabed on which the cell(s) are installed). The membrane(s) may be angled/inclined with respect to a vertical plane (i.e. perpendicular to the horizontal plane). Similarly, the membrane(s) may be oriented so as to be parallel with the horizontal plane or vertical plane.

In a third aspect, there is provided a method of converting wave energy to electrical energy using a cell according to the first aspect to provide a flow of energy transfer fluid e.g. air to a turbine in a closed power take-off system.

In a fourth aspect, there is provided a method of converting wave energy to electrical energy using a system according to the second aspect.

The method comprises distending the membrane (i.e. the working surface of the membrane) to the inflated (e.g. fully-inflated) configuration (i.e. away from the internal surface of the cell body) such that the surface area of the membrane (and the cell volume) in the inflated (e.g. fully-inflated) configuration is greater than the surface area in the rest configuration.

In some embodiments, the method comprises distending the membrane to the inflated (e.g. fully-inflated) configuration such that its surface area increases by 2% or greater e.g. by 5% or greater, such as 10% or greater, for example 20% or greater, 30% or greater, 40% or greater, 50% or greater, 60% or greater or 70% or greater, e.g. up to a maximum of 100% or 150% or 200%. In preferred embodiments, the method comprises distending the membrane such that its surface area increases by an amount between 20 and 80%, e.g. between 40% or 50% and 70% such as around 60%.

In some embodiments, the method comprises distending the membrane to the inflated (e.g. fully-inflated) configuration with the membrane under (tensile/positive) strain.

In some embodiments, the method comprises distending the membrane (i.e. the working surface of the membrane) to the inflated (e.g. fully-inflated) configuration through a plurality of inflated (i.e. partly-inflated) configurations such that the surface area of the membrane (and cell volume) in each of the (partly-)inflated configurations is greater than the surface area (and cell volume) in the rest configuration.

In some embodiments, the method comprises distending the membrane (i.e. the working surface of the membrane) such that it is under (positive/tensile) strain in all of the inflated configurations i.e. the partly- and fully-inflated configurations.

In some embodiments, the method comprises distending said membrane (i.e. the working surface of the membrane) to the deflated (e.g. fully-deflated) configuration (i.e. towards the internal surface of the cell body) such that the surface area of the membrane (and cell volume) in the deflated (e.g. fully-deflated) configuration is greater than the surface area in the rest configuration.

In some embodiments, the method comprises distending the membrane to the deflated (e.g. fully-deflated) configuration such that its surface area increases by 2% or greater e.g. by 5% or greater, such as 10% or greater, for example 20% or greater, 30% or greater, 40% or greater, 50% or greater, 60% or greater or 70% or greater, e.g. up to a maximum of 100% or 150% or 200%. In preferred embodiments, the method comprises distending the membrane such that its surface area increases by an amount between 20 and 80%, e.g. between 40% or 50% and 70% such as around 60%.

In some embodiments, the method comprises distending the membrane (i.e. the working surface of the membrane) to the deflated (e.g. fully-deflated) configuration with the membrane under (positive/tensile) strain.

In some embodiments, the method comprises distending the membrane (i.e. the working surface of the membrane) to the deflated (e.g. fully-deflated) configuration through a plurality of partly-deflated configurations such that the surface area of the membrane (and cell volume) in each of the (partly-)inflated configurations is greater than the surface area (and cell volume) in the rest configuration.

In some embodiments, the method comprises distending the membrane (i.e. the working surface of the membrane) such that it is under (positive/tensile) strain in all of the deflated (i.e. fully- and partly-deflated) configurations.

In some embodiments, the method comprises moving the membrane (i.e. the working surface of the membrane) from the inflated configuration (e.g. fully-inflated) to the deflated (e.g. fully-deflated) configuration in the deflation stroke with the membrane under positive/tensile strain during the entire deflation stroke.

In some embodiments, the method comprises moving the membrane (i.e. the working surface of the membrane) from the deflated (e.g. fully-deflated) configuration to the inflated (e.g. fully-inflated) configuration in the inflation stroke with the membrane under positive/tensile strain during the entire inflation stroke. The operation cycle/stroke of the membrane comprises the inflation and deflation strokes and in some embodiments, the method comprises moving the membrane (i.e. the working surface of the membrane) under positive/tensile strain for the entire operational cycle/stroke.

In these methods, as the membrane (i.e. the working surface of the membrane) is distended during a deflation stroke (e.g. from the rest configuration) to the deflated (e.g. fully-deflated) configuration or from the inflated (e.g. fully-inflated) configuration to the deflated (e.g. fully-deflated) configuration), the energy transfer fluid (e.g. air) within the cell volume is forced from the cell volume to create flow in an associated turbine in order to generate electrical energy. In some embodiments (where the turbine is a bidirectional turbine), as the membrane is distended during an inflation stroke (e.g. from the rest configuration to the inflated (e.g. fully-inflated) configuration or from the deflated (e.g. fully-deflated) configuration to the inflated (e.g. fully-inflated) configuration), the cell volume is replenished by a flow of energy transfer fluid to create flow in the associated turbine in order to generate electrical energy.

In some embodiments, the method comprises venting the cell body (cell volume) through the aperture during excessive inflation by breaking the seal formed by the membrane. This allows venting of the energy transfer fluid (air) through the seal.

In a fifth aspect, there is provided a method of manufacturing a wave energy converter cell for a pressure differential converter system comprising a turbine, the cell comprising a cell body defining an aperture, the method comprising providing a membrane having a distensible working surface covering the aperture and sealing the membrane over the aperture.

In some embodiments, the method comprises providing a substantially planar distensible membrane and sealing the substantially planar membrane over the aperture.

In some embodiments, the method comprises providing a membrane having a single, unitary surface and sealing the (joint free) membrane over the aperture. At least part of the surface (e.g. the entire surface) may be planar.

In some embodiments, the method comprises forming a membrane having a unitary structure (i.e. comprising a single layer).

In other embodiments, the method comprises forming a membrane having a layered/laminate structure (i.e. formed of a plurality of stacked layers formed of individual thinner membranes).

In some embodiments, the method comprises pre-straining the (unitary or laminated) membrane across the aperture e.g. pre-straining the membrane along two perpendicular axes. The method may comprise applying a pre-strain of greater than 10% e.g. between 10 and 50% such as up to 200%.

In some embodiments, the method comprises providing a membrane formed of a homogenous material (i.e. without any fibrous or mesh reinforcements in the working surface of the membrane sealing the aperture. In some embodiments, the method comprises providing a membrane formed of natural rubber e.g. natural rubber with a filler such as carbon black.

In some embodiments, the method comprises varying the thickness of the membrane across the working surface. For example, a central portion of the working surface of the membrane (which will be aligned with the centre of the aperture) may be provided with an increased thickness.

In some embodiments, the method comprises deflecting and tensioning the perimeter portion of the membrane over the curved perimeter/edge of the internal surface of the cell body.

In some embodiments, the method comprises securing the perimeter of the tensioned membrane to a support structure/skirt depending/extending downwardly from the curved bearing surface.

In some embodiments, the method may comprise connecting the perimeter portion of the membrane to a plurality of circumferentially spaced tethers/restraints e.g. ropes, cords or bungees and securing the tethers to the support structure/skirt.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 shows a first embodiment with the membrane in a rest configuration;

FIG. 2 shows the first embodiment with the membrane in a fully-deflated configuration;

FIG. 3 shows the first embodiment with the membrane in a fully-inflated configuration;

FIG. 4 shows part of the perimeter portion of the membrane; and

FIG. 5 shows a second embodiment with the membrane in a fully-inflated configuration.

### DETAILED DESCRIPTION AND FURTHER OPTIONAL FEATURES

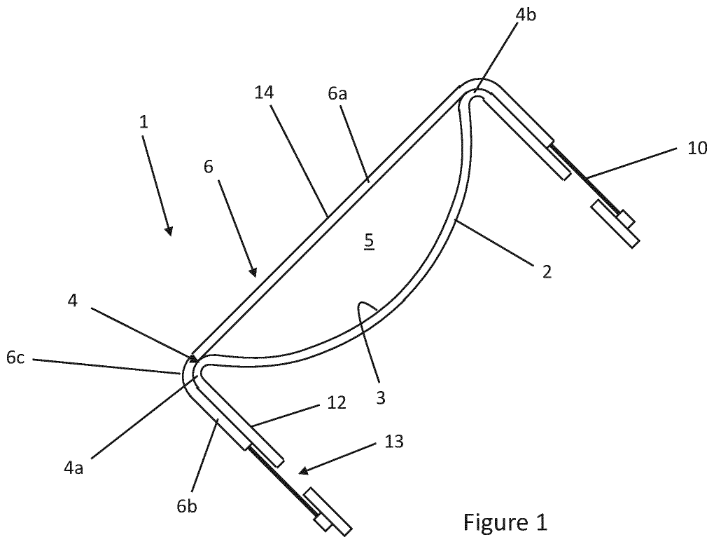

FIGS. 1 to 3 show a cross-section through a wave energy converter cell 1. The cell 1 is for use in a pressure differential converter system having a power take-off system comprising a turbine.

The cell 1 comprises a cell body 2 having an internal concave surface 3 which provides a basin- or bowl-shaped cell body 2. The cell body 2 may be formed of stainless steel or concrete, for example, and may be treated to improve corrosion resistance from salt water.

The concave surface 3 is encircled by a perimeter/edge 4 which includes a lower forward linear edge 4a and an upper rearward linear edge 4b. Not shown are opposing curved transverse edges which space the forward and rearward edges 4a, 4b (to form an oval race track shaped edge when viewed from directly above the aperture). The forward edge 4a and rearward edge 4b are in the same plane as the transverse edges (although in other embodiments, one or both may be deflected above or below the plane of the transverse edges). The perimeter/edge 4 of the internal surface 3 defines an aperture. The aperture may be substantially circular or elliptical. The perimeter/edge 4 encircling the aperture is a rolled or curved bearing surface having a bend radius.

The cell 1 further comprises a distensible membrane 6 which has a working surface 6a which is provided across and seals the aperture defined by the perimeter/edge 4. The working surface 6a of the membrane, along with the internal concave surface 3 of the cell body 2 defines a cell volume 5. The cell volume 5 contains air as an energy transfer fluid.

FIG. 1 shows the cell 1 when the membrane 6 is in the rest configuration. This is the configuration when there is no hydrostatic pressure on the membrane 6. It is the configuration that the membrane 6 will adopt at least prior to installation of the cell subsea and with internal air pressure equal to external air pressure.

The chord length of the membrane in the rest configuration shown in FIG. 1 is about 1 i.e. the length of the (working surface 6a) of the membrane 6 between the lower forward edge 4a and upper rearward edge 4b is substantially the same as the straight-line distance between the lower forward edge 4a and upper rearward edge 4b. In effect, this means that the working surface 6a of the membrane 6 is substantially planar across the aperture.

This significantly reduces manufacturing complexity and costs of the membrane 6 as a planar membrane can be easily cast/moulded.

The membrane 6 is formed of a unitary piece of natural rubber having a homogenous distribution of carbon black. There are no joins and no fibrous/mesh reinforcements, at least not in the working surface 6a of the membrane 6. It may have a Shore A Hardness of around 60.

In alternative embodiments (not shown here), the membrane 6 may be formed of a series of stacked thinner membranes.

The membrane 6 further comprises a perimeter portion 6b which circumscribes the working surface 6a of the membrane 6.

The thickness of the membrane 6 varies. It is thicker in both a central portion 14 of the working surface 6a and in the outermost regions of the perimeter portion 6b. The thickness of the membrane in the un-thickened portions may be around 50 mm.

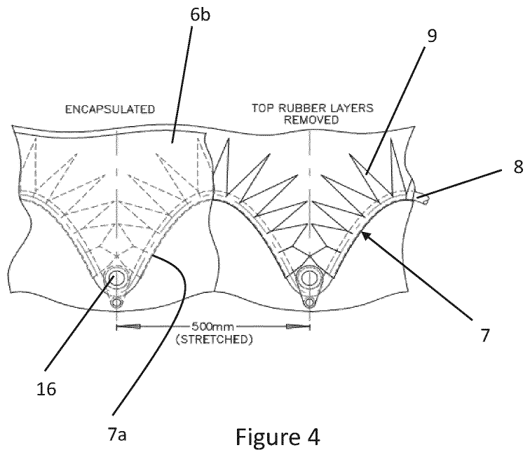

The perimeter portion 6b has a scalloped edge 7 (as shown in FIG. 4) which is reinforced with a perimeter rope 8. The scalloped edge 7 comprises reinforcing elements 9 which are embedded within the rubber forming the perimeter portion 6b. Eyelets 16 are provided at the peaks 7a of the scalloped edge 7 and rope tethers 10 secure the perimeter portion 6b to clamps 11 provided on a skirt 12 which depends from the perimeter/edge 4. The skirt 12 (which is also formed of stainless steel and is formed integrally with the rest of the cell body 2) comprises perforations 13 to reduce the weight of the cell body 2.

Once in position on the cell body 2, the membrane 6 is pre-strained by applying a tensile force in the plane of the membrane 6. The tensile force is applied using the rope tethers 10 to stretch the working surface 6a and perimeter portion 6b of the membrane 6. A pre-strain of around 10-50% may be applied.

The perimeter portion 6b of the membrane 6 is deflected and tensioned over the curved bearing surface 4 of the internal surface 3 to seal the membrane 6 to the curved bearing surface 4 thereby sealing the aperture. The membrane 6 is tensioned to conform to the curved bearing surface 4 of the internal surface 3. By deflecting the membrane around a curved bearing surface, the bending stress in the membrane 6 reduced because it is limited by the curve of the curved bearing surface 4.

By forming the seal by tensioning the membrane 6 over the curved bearing surface 4, a “one-sided seal” is provided i.e. an outer surface 6c of the membrane 6 in the region of the seal is exposed.

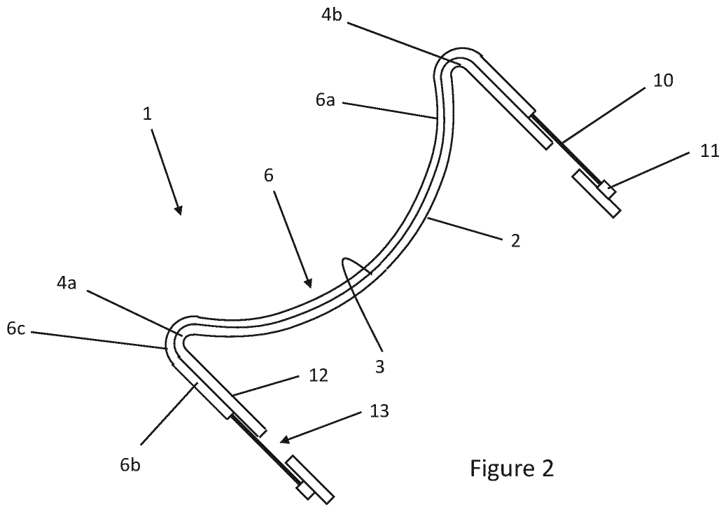

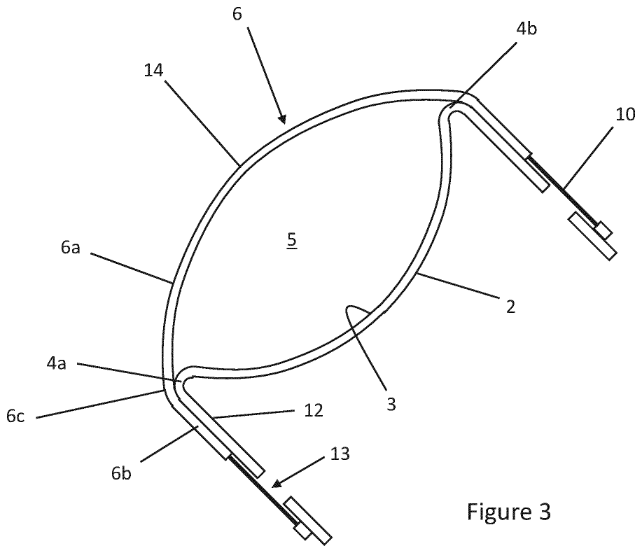

The cell volume 5 is variable by distension of the working surface 6a of the membrane 6 away from the internal surface 3 (in an inflation stroke) to a fully-inflated configuration caused by a decrease in hydrostatic pressure resulting from a wave trough (shown in FIG. 2) and towards the internal surface 3 (in a deflation stroke) to a fully-deflated configuration caused by an increase in hydrostatic pressure resulting from a wave peak (shown in FIG. 3). During a deflation stroke, air from the cell volume 5 is forced out of the cell volume through an outlet (not shown) comprising a one-way valve in the internal concave surface 3. The flow of air causes rotation of the turbine and generation of electrical energy. During an inflation stroke, the cell volume 5 is replenished with air through an inlet (not shown) comprising a one-way valve in the internal concave surface 3. Where the turbine is a bidirectional turbine, the return flow of air also causes rotation of the turbine and generation of electrical energy.

A complete operation stroke/cycle of the membrane 6 comprises a complete inflation and deflation stroke e.g. from the fully-inflated configuration (FIG. 3) to the fully-deflated configuration (FIG. 2). The surface area and chord length ratio are both greater in both of the fully-inflated and fully-deflated configurations than in the rest configuration. They are also greater in all intermediate positions between the fully-inflated and fully-deflated configurations.

This means that the membrane 6 is constantly under strain during both the inflation stroke and the deflation stroke. Given that the membrane 6 is also pre-strained in the rest configuration, it can be seen that the membrane 6 is constantly under strain during the entire operational cycle. This means that creasing and buckling in the membrane 6 are eliminated thus eliminating bending stresses in the membrane 6.

Furthermore, by using a distensible membrane 6, the PV stiffness becomes dependent not only on the hydrostatic stiffness but also on the mechanical stiffness of the membrane 6. The mechanical stiffness (which is attributable in part to the elastomeric nature of the distensible rubber membrane) can be used to off-set the hydrostatic stiffness. The mechanical stiffness may be equal and opposite to the membrane hydrostatic stiffness (as previously defined herein).

The pre-straining of the membrane 6 increases the minimum strain in the membrane 6 and improves the fatigue life of the membrane by preventing the undesirable cycling between positive and negative strain the during an operational cycle (i.e. during the inflation and deflation strokes).

In the embodiment shown in FIGS. 1 to 3, damage to the membrane 6 by over inflation is avoided by allowing venting of the energy transfer fluid (air) through the seal between the membrane 6 and the curved bearing surface 4 (thus breaking the seal) during excessive wave conditions.

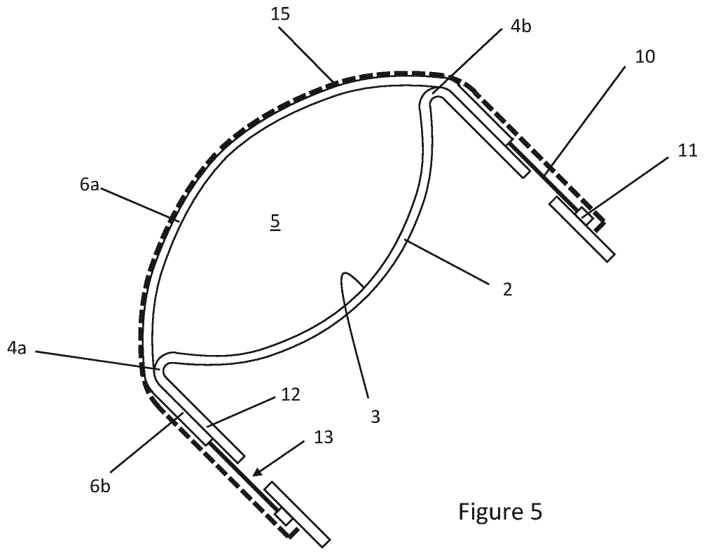

In a second embodiment shown in the fully-inflated configuration in FIG. 5, the cell 1 further comprises a meshed, domed cage 15 that defines the inflation limit of the membrane 6. The cage 15 extends from the cell body away from the aperture. In this way, during any excessive inflation, the working surface 6a of the membrane 6 will abut an inner surface (e.g. a concave inner surface) of the cage 15 thus preventing further distension.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1-38. (canceled)

39. A wave energy converter cell for a pressure differential converter system comprising a turbine, the cell comprising a cell body defining an aperture and a membrane sealing said aperture wherein said membrane has a working surface covering said aperture and wherein said working surface is distensible such that its surface area can increase by an amount of 5% or greater.

40. A wave energy converter cell according to claim 39 wherein the working surface has a mechanical stiffness which is substantially equal and opposite to its membrane hydrostatic stiffness.

41. A wave energy converter according to claim 39 wherein the working surface of the membrane is pre-strained across the aperture in a rest configuration.

42. A wave energy converter according to claim 41 wherein the chord ratio equals about 1 such that the membrane is substantially planar across the aperture in the rest configuration.

43. A wave energy converter according to claim 39 wherein the membrane comprises a single, unitary surface which is planar across at least part of the aperture.

44. A wave energy converter according to claim 39 wherein the working surface of the membrane comprises a homogenous material.

45. A wave energy converter according to claim 39 wherein the thickness of the working surface of the membrane varies.

46. A wave energy converter according to claim 39 wherein the membrane comprises a plurality of stacked thinner membranes.

47. A wave energy converter according to claim 39 wherein the cell body comprises an internal surface which, along with the distensible working surface of the membrane defines a cell volume.

48. A wave energy converter according to claim 47 wherein the perimeter of the internal surface comprises a forward curved edge and a rearward curved edge spaced by opposing transverse linear edges wherein the forward, rearward and transverse edges are all in the same plane.

49. A wave energy converter according to claim 47 wherein the perimeter of the internal surface comprises a forward curved edge and a rearward curved edge spaced by opposing transverse edges wherein at least one of the forward and/or rearward edges are deflected above or below the plane of the opposing transverse edges and wherein the membrane is deflected and tensioned over the curved edge of the internal surface to seal the membrane to the curved edge thereby sealing the aperture.

50. A wave energy converter according to claim 39 wherein a perimeter portion of the membrane is secured to a support structure and/or wherein the perimeter portion of the membrane is thicker or thinner than the working surface of the membrane.

51. (canceled)

52. A wave energy converter according to claim 50 wherein the perimeter portion of the membrane comprises reinforcing elements.

53. A wave energy converter according to claim 50 wherein the perimeter portion of the membrane comprises a plurality of circumferentially-spaced membrane connectors.

54. A pressure differential wave energy converter system comprising at least one cell according to claim 39 and a closed power take-off system comprising a turbine.

55. A method of manufacturing a wave energy converter cell for a pressure differential converter system comprising a turbine, the cell comprising a cell body defining an aperture, the method comprising providing a membrane having a distensible working surface capable if increasing its surface area by an amount of 5% or greater and sealing the membrane over the aperture.

56. A method according to claim 55 comprising providing a substantially planar distensible membrane and sealing the substantially planar membrane over the aperture.

57. A method according to claim 55 comprising providing a membrane having a single, unitary planar surface and sealing the membrane over the aperture.

58. A method according to claim 55 comprising pre-straining the working surface of the membrane across the aperture.

59. A method of converting wave energy to electrical energy using a pressure differential converter system according to claim 54, the method comprising distending the working surface of said membrane by an amount of 5% or greater to drive an energy transfer fluid from the cell to the turbine.
